(19) United States
(12) Patent Application Publication
(10) Pub. No.: US 2011/0305281 A1
(43) Pub. Date: Dec. 15, 2011

(54) RECEIVER, RECEIVING METHOD, AND COMMUNICATION SYSTEM

(75) Inventors: Osamu Yoshimura, Kanagawa (JP); Hideki Iwami, Saitama (JP); Chihiro Fujita, Kanagawa (JP); Hideaki Murayama, Kanagawa (JP); Tamotsu Munakata, Kanagawa (JP); Yoshinobu Kure, Kanagawa (JP)

(73) Assignee: Sony Corporation, Tokyo (JP)

(21) Appl. No.: 13/150,342

(22) Filed: Jun. 1, 2011

(30) Foreign Application Priority Data
Jun. 9, 2010 (JP) 2010-132459

(51) Int. Cl. H04N 7/26

(52) U.S. Cl. 375/240.25; 375/E07.027

(57) ABSTRACT

A receiver includes a receiving section that receives communication packets transmitted from a transmitter, which transmits the communication packets each including encoded data, and an image header, sequentially from the encoded data corresponding to the beginning of an image, a first accumulating section that accumulates the encoded data and the image header included in each of the received communication packets, a detecting section that detects a picture header transmitted together with the encoded data corresponding to the beginning of the image, from the image header of each of the received communication packets, in a predetermined observation interval, a second accumulating section that accumulates the detected picture header, and a control section that reads out the picture header accumulated in the second accumulating section, and causes the picture header to be accumulated into the first accumulating section, if the picture header is not detected within the observation interval.

### BACKGROUND

The present disclosure relates to a receiver, a receiving method, and a communication system, in particular, a receiver, a receiving method, and a communication system which make it possible to receive data with low delay and high quality.

In the related art, applications and services that transfer image data (in particular, moving image data) via various networks such as the Internet and a Local Area Network (LAN) are in widespread use. Generally, when transmitting and receiving image data via a network, the image data is reduced in size by an encoding (compression) process such as Moving Pictures Experts Group (MPEG) or Joint Photographic Experts Group 2000 (JPEG 2000) before being sent out to the network. Then, on the receiving side that receives the encoded image data, a decoding (decompression) process is applied to reproduce the image data.

In recent years, for camera systems designed for live relay broadcasting, there is a demand for delivery of image data by high-image-quality, low-delay transmission. However, in encoding schemes such as MPEG and JPEG 2000, the code delay (encoding delay+decoding delay) is two pictures or more. Thus, there is a desire for an encoding scheme that enables transmission with lower delay.

Accordingly, in these days, image compression schemes (hereinafter referred to as line-based codecs) are beginning to be proposed which achieve a shorter delay time by splitting a single picture into sets of N lines (N is equal to or larger than 1), and encoding the image by each split set (referred to as a line block) at a time. Advantages of line-based codecs include, in addition to low delay transmission, the ability to achieve high speed processing and reduced hardware scale, because the amount of information to be handled per one unit of image compression is small.

For example, Japanese Unexamined Patent Application Publication No. 2007-311948 describes a communication device that performs the process of appropriately complementing missing data on a line-block basis, with respect to communication data based on a line-based codec. Also, Japanese Unexamined Patent Application Publication No. 2009-278545 describes a communication device that can acquire synchronization in a stable manner in communications using a line-based codec.

Use of such line-based codecs achieves transmission with low delay and high image quality. Thus, application of line-based codecs to camera systems designed for live relay broadcasting is being anticipated in the coming years.

### SUMMARY

In the case of transferring images compressed by a line-based codec via a communication medium, how to establish timing synchronization between a transmitting terminal and a receiving terminal becomes a problem. Generally, on the receiving terminal side, a reproduction process is performed in frame units by using time information (for example, Time Stamp) inserted in the header of packets, a vertical synchronizing signal (VSYNC), a horizontal synchronizing signal (HSYNC), Start of Active Video (SAV) or End of Active Video (EAV) which is a known signal appended to the beginning and end of a blank period, or the like. Accordingly, at the receiving terminal, by using the above-mentioned synchronizing signal or the above-mentioned known signal as a reference to start decoding after the period of one frame at the shortest, the decoding process can be performed more easily.

However, to take advantage of the low delay characteristic of line-based codecs while keeping the data rate within the bandwidth of a transmission path, data is compressed so as to become a predetermined data transfer size. Also, the data compression ratio of the pixel (or line or group of lines) in question is determined by the size of data received before the pixel (or line or group of lines) in question. For these reasons, in line-based codecs, the control time for data transfer size becomes short in comparison to picture-based codecs.

Further, when the data size of a given pixel (line or group of lines) temporarily increases, an amount of transmit data in excess of what can be transmitted to the transmission path is sometimes temporarily accumulated in a buffer on the transmitting terminal side. Thus, a situation arises in which transmit data is transmitted at a timing delayed from the transmission output timing at which the transmit data should be transmitted.

To adapt camera systems designed for live relay broadcasting according to the related art to general-purpose lines, such as the Ethernet®, NGN, and wireless, while also achieving high image quality, a situation arises in which an increase in delay or packet loss occurs.

If, due to the above-mentioned situation in which delay of transmission output timing, an increase in delay, or packet loss occurs, for example, a packet including picture decode information of a line-based codec (hereinafter, referred to as picture header packets) is delayed in transmission or lost, a situation arises in which on the receiving terminal side, the receiving terminal is unable to reference the picture header during the decoding process. In this case, the quality of images reproduced on the receiving terminal side decreases. Accordingly, there is a desire for a method which makes it possible to take advantage of the low delay characteristic of a line-based codec, and also prevent a decrease in image quality, even in the above-mentioned situation.

It is desirable to enable image data encoded using a line-based codec to be received with low delay and high quality (high image quality).

A receiver according to an embodiment of the present disclosure includes a receiving section that receives communication packets transmitted from a transmitter, the transmitter transmitting the communication packets each including encoded data obtained by encoding image data, and an image header containing information related to the image data, sequentially from the encoded data corresponding to the beginning of an image, a first accumulating section that accumulates the encoded data and the image header included in each of the communication packets received by the receiving section, a detecting section that detects a picture header from the image header of each of the communication packets received by the receiving section, in a predetermined observation interval, the picture header being transmitted together with the encoded data corresponding to the beginning of the image, a second accumulating section that accumulates the picture header detected by the detecting section, and a control section that reads out the picture header accumulated in the second accumulating section, and causes the picture header to be accumulated into the first accumulating section, if the picture header is not detected by the detecting section within the observation interval.

A receiving method according to an embodiment of the present disclosure includes receiving communication packets transmitted from a transmitter, the transmitter transmitting the communication packets each including encoded data obtained by encoding image data, and an image header containing information related to the image data, sequentially from the encoded data corresponding to the beginning of an image, accumulating the encoded data and the image header included in each of the received communication packets into a first accumulating section, detecting a picture header from the image header of each of the communication packets, in a predetermined observation interval, the picture header being transmitted together with the encoded data corresponding to the beginning of the image, accumulating the detected picture header into a second accumulating section, and reading out the picture header accumulated in the second accumulating section, and causing the picture header to be accumulated into the first accumulating section, if the picture header is not detected within the observation interval.

A communication system according to an embodiment of the present disclosure includes a transmitter and a receiver. The transmitter transmits communication packets each including encoded data obtained by encoding image data, and an image header containing information related to the image data, sequentially from the encoded data corresponding to the beginning of an image. The receiver has a receiving section that receives the communication packets transmitted from the transmitter, a first accumulating section that accumulates the encoded data and the image header included in each of the communication packets received by the receiving section, a detecting section that detects a picture header from the image header of each of the communication packets received by the receiving section, in a predetermined observation interval, the picture header being transmitted together with the encoded data corresponding to the beginning of the image, a second accumulating section that accumulates the picture header detected by the detecting section, and a control section that reads out the picture header accumulated in the second accumulating section, and causes the picture header to be accumulated into the first accumulating section, if the picture header is not detected by the detecting section within the observation interval.

According to an embodiment of the present disclosure, communication packets transmitted from a transmitter are received. The transmitter transmits the communication packets each including encoded data obtained by encoding image data, and an image header containing information related to the image data, sequentially from the encoded data corresponding to the beginning of an image. The encoded data and the image header included in each of the received communication packets are accumulated into a first accumulating section. Then, in a predetermined observation interval, a picture header, which is transmitted together with the encoded data corresponding to the beginning of the image, is detected from the image header of each of the communication packets, and the detected picture header is accumulated into a second accumulation section. If the picture header is not detected within the observation interval, the picture header accumulated in the second accumulating section is read out, and accumulated into the first accumulating section.

According to an embodiment of the present disclosure, image data encoded using a line-based codec can be transmitted with low delay while also preventing a decrease in image quality.

### BRIEF DESCRIPTION OF THE DRAWINGS

FIG. 1 is a diagram showing an example of the configuration of an encoder that encodes image data;

FIG. 2 is a diagram showing the structure of coefficient data split by repeating analysis filtering four times;

FIG. 3 is a diagram for explaining line blocks;

FIG. 4 is a block diagram showing an example of the configuration of a communication system according to an embodiment of the present disclosure;

FIG. 5 is a diagram showing the frame format of an IP packet;

FIG. 6 is a diagram showing a general data structure for a picture header packet;

FIG. 7 is a block diagram showing a detailed configuration of a receive memory section;

FIG. 8 is a diagram for explaining an observation interval;

FIG. 9 is a flowchart for explaining a transmit process which transmits image data;

FIG. 10 is a flowchart for explaining a receive process which receives image data;

FIG. 11 is a flowchart for explaining a data accumulation process;

FIG. 12 is a flowchart for explaining a decoding process for each coding unit; and

FIG. 13 is a block diagram showing an example of the configuration of a computer according to an embodiment of the present disclosure.

### DETAILED DESCRIPTION OF EMBODIMENTS

Hereinbelow, specific embodiments of the present disclosure will be described in detail with reference to the drawings.

First, an image data encoding process will be described.

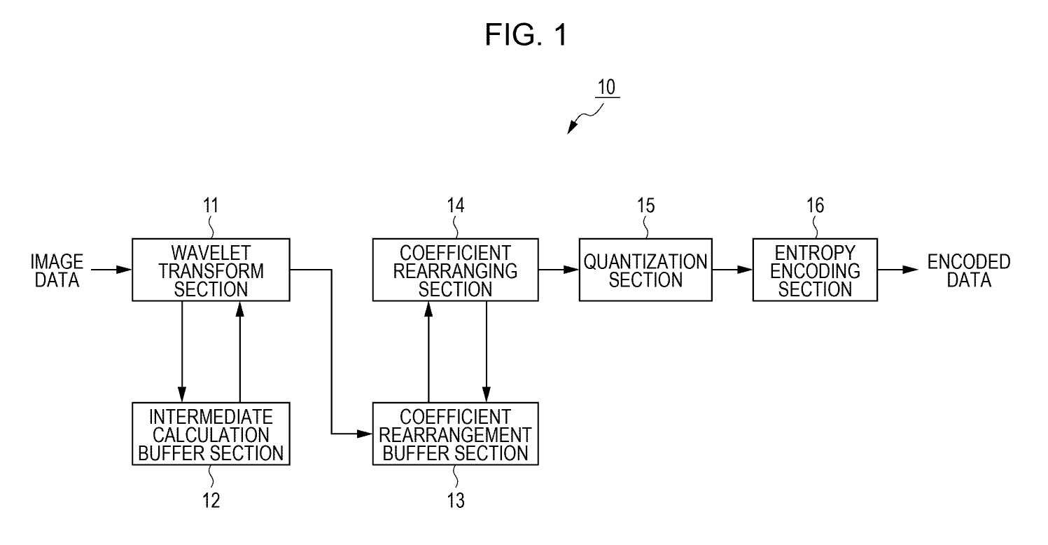

FIG. 1 is a diagram showing an example of the configuration of an encoder that encodes image data.

An encoder 10 shown in FIG. 1 generates and outputs encoded data by encoding inputted image data. As shown in FIG. 1, the encoder 10 has a wavelet transform section 11, an intermediate calculation buffer section 12, a coefficient rearrangement buffer section 13, a coefficient rearranging section 14, a quantization section 15, and an entropy encoding section 16.

Image data inputted to the encoder 10 is temporarily accumulated in the intermediate calculation buffer section 12 via the wavelet transform section 11.

The wavelet transform section 11 applies a wavelet transform to the image data accumulated in the intermediate calculation buffer section 12. Details of this wavelet transform will be described later. The wavelet transform section 11 supplies coefficient data obtained by the wavelet transform to the coefficient rearrangement buffer section 13.

The coefficient rearranging section 14 reads out the coefficient data described to the coefficient rearrangement buffer section 13 in a predetermined order (for example, in the order of inverse wavelet transform process), and supplies the data to the quantization section 15.

The quantization section 15 quantizes the supplied coefficient data by a predetermined method, and supplies the obtained coefficient data (quantized coefficient data) to the entropy encoding section 16.

The entropy encoding section 16 encodes the supplied coefficient data in a predetermined entropy encoding scheme, such as Huffman encoding or arithmetic encoding. The entropy encoding section 16 outputs the generated encoded data to the outside of the encoder 10.

Next, a wavelet transform will be described. A wavelet transform is a process of recursively repeating analysis filtering, which splits image data into components of high spatial frequency (high-frequency components) and components of low spatial frequency (low-frequency components), with respect to generated low-frequency components, thereby transforming the image data into coefficient data structured in a layered manner and separated for each individual frequency component. It should be noted that in the following, the splitting level is lower for layers of higher frequency components, and is higher for layers of lower frequency components.

In one layer (splitting level), analysis filtering is performed with respect to both the horizontal direction and the vertical direction. Consequently, coefficient data (image data) in one layer is split into four kinds of components through one layer of analysis filtering. The four kinds of components are components (HH) that are of high frequency with respect to both the horizontal direction and the vertical direction, components (HL) that are of high frequency with respect to the horizontal direction and of low frequency with respect to the vertical direction, components (LH) that are of low frequency with respect to the horizontal direction and of high frequency with respect to the vertical direction, and components (LL) that are of low frequency with respect to both the horizontal direction and the vertical direction. Each set of the respective components will be referred to as subband.

In a state in which four subbands are generated by performing analysis filtering in a given layer, analysis filtering in the next (immediately higher) layer is applied to, among the four generated subbands, components (LL) that are of low frequency with respect to both the horizontal direction and the vertical direction.

As analysis filtering is recursively repeated in this way, coefficient data in a band of low spatial frequencies is narrowed down into smaller regions (lower frequency components). Therefore, efficient encoding is possible by encoding such wavelet-transformed coefficient data.

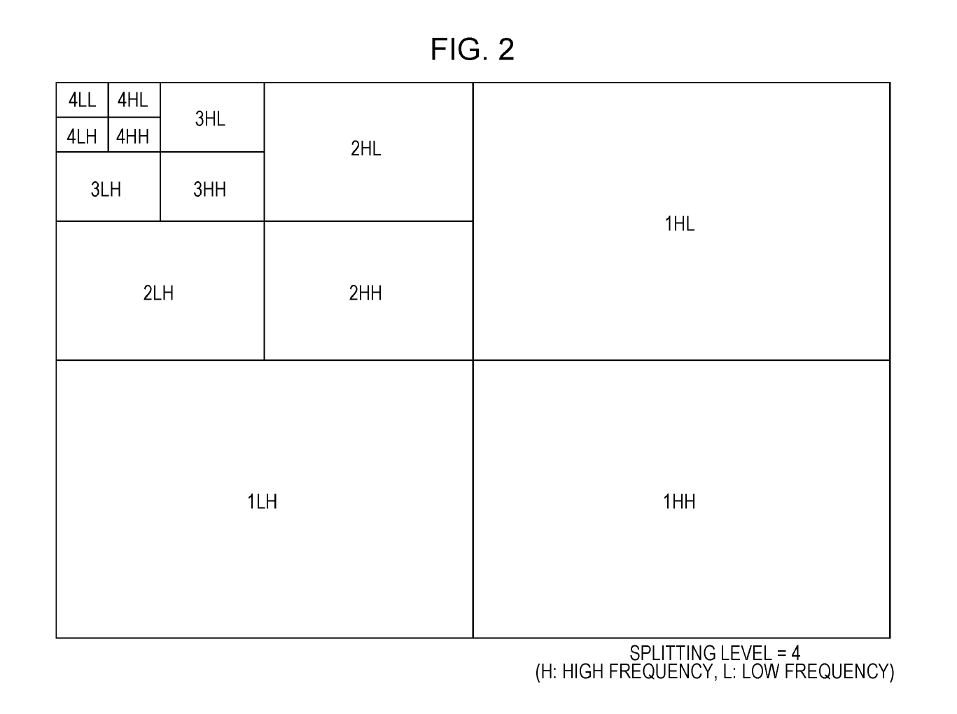

FIG. 2 shows the structure of coefficient data split into 13 subbands (1LH, 1HL, 1HH, 2LH, 2HL, 2HH, 3LH, 3HL, 3HH, 4LL, 4LH, 4HL, and 4HH) up to splitting level 4 by repeating analysis filtering four times.

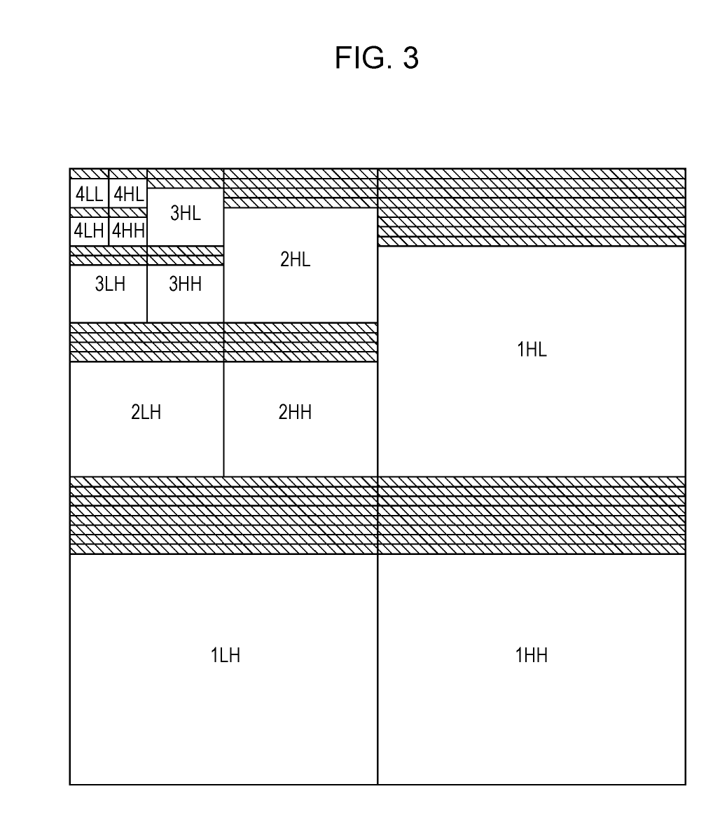

Next, line blocks will be described. FIG. 3 is a diagram illustrating line blocks. Analysis filtering in a wavelet transform generates coefficient data of the four subbands in the next higher layer from two lines of image data or coefficient data to be processed.

Therefore, for example, when the number of splitting levels is four, as indicated by the diagonal lines in FIG. 3, to obtain one line of coefficient data of each of the subbands at splitting level 4 as the highest layer, two lines of coefficient data of the subband 3LL are necessary.

To obtain two lines of the subband 3LL, that is, to obtain two lines of coefficient data of each of the subbands at splitting level 3, four lines of coefficient data of the subband 2LL are necessary.

To obtain four lines of the subband 2LL, that is, to obtain four lines of coefficient data of each of the subbands at splitting level 2, eight lines of coefficient data of the subband 1LL are necessary.

To obtain eight lines of the subband 1LL, that is, to obtain eight lines of coefficient data of each of the subbands at splitting level 1, 16 lines of coefficient data of the baseband are necessary.

That is, to obtain one line of coefficient data of each of the subbands at splitting level 4, 16 lines of image data of the baseband are necessary.

The number of lines of image data necessary for generating one line of coefficient data of the subband of the lowest frequency components (4LL in the case of FIG. 3) will be referred to as line block (or precinct).

For example, when the number of splitting levels is M, to generate one line of coefficient data of the subband of the lowest frequency components, the number of lines of image data of the baseband equal to the M-th power of 2 are necessary. This is the number of lines of a line block.

It should be noted that a line block also indicates a set of coefficient data of individual subbands obtained by wavelet transform of the one line block of image data.

Also, a line indicates a row of pixels in the horizontal direction of one row's worth of frame image (picture), or a row of coefficients in the horizontal direction of one row's worth of subband. This one line of coefficient data will be also referred to as coefficient line. Also, one line of image data will be also referred to as image line. In the following, these expressions will be changed as appropriate in cases where a more detailed differentiation is necessary.

Also, one line of encoded data obtained by encoding one coefficient line (one line of coefficient data) will be also referred to as encoded line.

According to the line-based wavelet transform process mentioned above, like tiling in JPEG 2000, it is possible to decompose a single picture to a finer granularity for processing, thereby reducing delay at the time of transmitting and receiving image data. Further, in the case of a line-based wavelet transform, unlike tiling in JPEG 2000, instead of splitting a single baseband signal, splitting using wavelet coefficients is performed. Hence, a line-based wavelet transform also has a characteristic that block noise-like image quality degradation does not occur at tile boundaries.

The foregoing description is directed to the line-based wavelet transform as an example of a line-based codec. It should be noted that embodiments of the present disclosure described below can be applied to not only a line-based wavelet transform but also an arbitrary line-based codec, for example, an existing layered encoding such as JPEG 2000 or MPEG-4.

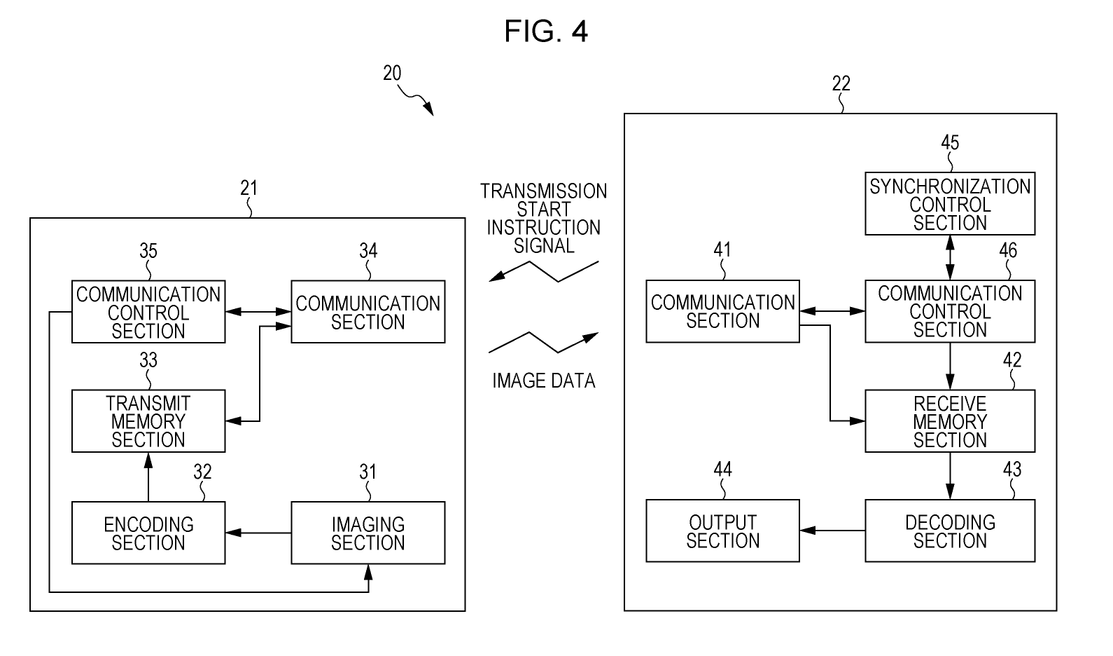

FIG. 4 is a block diagram showing an example of the configuration of a communication system according to an embodiment of the present disclosure.

In FIG. 4, a communication system 20 includes a camera 21 and a camera controller 22. The connection between the camera 21 and the camera controller 22 is made by, for example, radio communication based on a standard specification such as IEEE 802.11a, b, g, n, s, or a general-purpose line such as the Ethernet® or Next Generation Network (NGN).

The camera 21 includes a function as a transmitter that captures a subject, generates a series of image data, and transmits the series of image data. The camera controller 22 includes a function as a receiver that performs control on the camera 21 to receive images transmitted from the camera 21.

It should be noted that the communication system 20 can be configured in such a way that the camera 21 and the camera controller 22 are not in a one-to-one relation but, for example, a single camera controller 22 performs control on a plurality of cameras 21 to receive images transmitted from the plurality of cameras 21. That is, the communication system 20 may include a plurality of cameras 21.

The camera 21 includes an imaging section 31, an encoding section 32, a transmit memory section 33, a communication section 34, and a communication control section 35. As the camera 21, for example, a video camera, or a digital still camera, a personal computer, a mobile phone, or a game machine with a moving image shooting function may be employed.

The imaging section 31 includes an imaging device such as a Charge Coupled Device (CCD) or a Complementary Metal Oxide Semiconductor (CMOS). The imaging section 31 supplies image data obtained by imaging by the imaging device to the encoding section 32.

The encoding section 32 corresponds to the encoder 10 shown in FIG. 1. The encoding section 32 encodes image data in accordance with the above-mentioned line-based codec. That is, the encoding section 32 encodes the image data supplied from the imaging section 31 in coding units of N lines (N is not smaller than 1) in one field to reduce the data size, and then outputs the image data that has been encoded (encoded data) to the transmit memory section 33.

The transmit memory section 33 temporarily accumulates the encoded data supplied from the encoding section 32. Also, the transmit memory section 33 may have a routing function that manages routing information in according with the network environment and, for example, if the communication system 20 includes a plurality of cameras 21, controls transfer of data to another terminal (the camera 21).

The communication section 34 performs communication with the camera controller 22 in accordance with control by the communication control section 35. For example, the communication section 34 reads out encoded data accumulated in the transmit memory section 33 at a timing as controlled by the communication control section 35, and transmits the read encoded data to the camera controller 22. For example, the communication section 34 splits one picture's worth of encoded data into a plurality of parts, generates a plurality of communication packets each including the split encoded data, and sequentially transmits the series of image data. Also, for example, when a communication packet from the camera controller 22 is received, the communication section 34 analyzes the received packet, separates control data that should be passed on to the communication control section 35, and outputs the separated control data to the communication control section 35.

The communication control section 35 performs routing control and QoS-based control related to wireless lines, and also adjusts the transmit timing of image data with respect to the camera controller 22. More specifically, the communication control section 35 receives a transmission start instruction signal (control data) transmitted from the camera controller 22, via the communication section 34, and controls the communication section 34 so as to start transmission of communication packets at a transmission start time instant specified by the transmission start instruction signal. Thus, the communication section 34 reads out data accumulated in the transmit memory section 33 to generate communication packets, and transmits the communication packets at a timing according to the transmission start time instant.

The camera controller 22 includes a communication section 41, a receive memory section 42, a decoding section 43, an output section 44, a synchronization control section 45, and a communication control section 46. As the camera controller 22, a device acting as a master that determines the transmit/receive timing of image data with respect to the camera 21 can be employed, such as a personal computer, a video processor for home use such as a video recorder, a communication device, or an arbitrary information processor.

The communication section 41 performs communication with the camera 21 in accordance with control by the communication control section 46. For example, when instructed to transmit a transmit start instruction signal, the communication section 41 generates a communication packet including the transmit start instruction signal, and transmits the communication packet to the camera 21. Also, for example, upon receiving a communication packet including encoded data transmitted from the camera 21, the communication section 41 extracts the encoded data from the communication packet, and outputs the extracted encoded data to the receive memory section 42.

The receive memory section 42 temporarily accumulates the encoded data outputted from the communication section 41, in accordance with control by the communication control section 46, and then outputs the encoded data to the decoding section 43 at a predetermined decoding start time point. In the receive memory section 42, a decoding start time instant specified from the communication control section 46 is determined as the decoding start time point for image data.

The decoding section 43 decodes the encoded data outputted from the receive memory section 42 in units of N lines (N is not smaller than 1) in one field, and then outputs the image data obtained as a result of the decoding to the output section 44. The output section 44 outputs images according to the image data decoded in the decoding section 43.

The synchronization control section 45 acts as a timing controller that controls the transmit/receive timing of image data between devices within the communication system 20. For example, a time stamp included in a communication packet received by the communication section (for example, a time stamp for line control layer synchronization) is supplied to the synchronization control section 45 via the communication control section 46. The synchronization control section 45 references this time stamp to adjust a synchronizing signal indicating the timing for line synchronization, and outputs the adjusted synchronizing signal. The synchronization control section 45 is typically implemented as processing in the application layer.

Like the communication control section 35, the communication control section 46 performs routing control and QoS-based control related to wireless lines, and also adjusts the transmit timing of image data with respect to the camera 21, in accordance with the synchronizing signal outputted from the synchronization control section 45.

This adjustment of the transmit/receive timing of image data is started with an instruction from the application being executed in the camera controller 22, reception of a synchronization request signal from the camera 21, or the like as a trigger. Then, in accordance with the synchronizing signal from the synchronization control section 45, the communication control section 46 transmits a transmission start instruction signal that specifies a transmission start time instant for image data, to the camera 21 via the communication section 41, and specifies a decoding start time instant for image data with respect to the receive memory section 42. At this time, the decoding start time instant for image data specified with respect to the receive memory section 42 is a time instant obtained by subtracting the time necessary for absorbing a delay such as a delay caused by fluctuations in data size of each coding unit or fluctuations in communication environment such as jitters of communication paths, a hardware delay, or a memory delay, from a transmission start time instant for image data transmitted to the camera 21.

The camera 21 and the camera controller 22 are configured in this way. Image data captured by the camera 21 is transmitted to the camera controller 22, and received by the camera controller 22 and outputted.

In the case where, for example, communication based on the Internet Protocol (IP) is performed between the camera 21 and the camera controller 22, in the camera 21, the communication section 34 generates IP packets including encoded data read out from the transmit memory section 33, and the transmit process of a series of image data in coding units is executed.

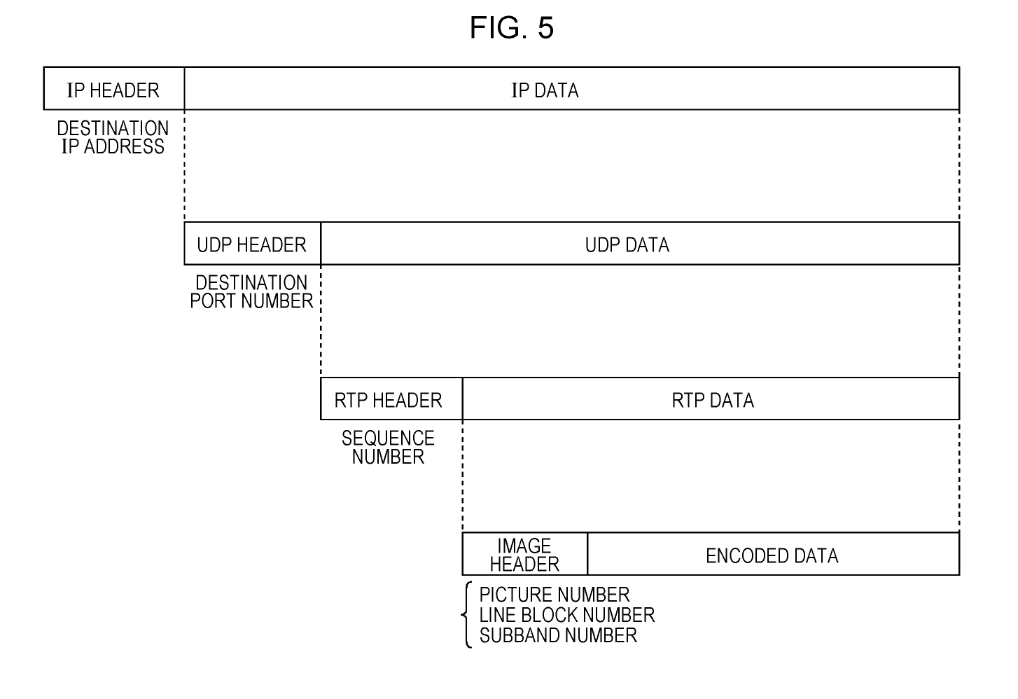

Referring to FIG. 5, a description will be given of the frame format of an IP packet, which is an example of communication data that can be transmitted and received between the camera 21 and the camera controller 22. FIG. 5 shows the internal structure of a single IP packet as divided in four stages.

First, the IP packet is made up of an IP header and IP data. The IP header contains, for example, control information related to control of communication paths based on the IP protocol, such as a destination IP address.

The IP data is further made up of a UDP header and UDP data. The UDP is a protocol at the transport layer of the OSI reference model, which is generally used for applications such as delivery of moving image or audio data for which real-timeness is regarded as important. The UDP header contains, for example, a destination port number, which is application identification information.

The UDP data is further made up of an RTP header and RTP data. The RTP header contains, for example, control information for ensuring real-timeness of a data stream such as a sequence number.

The RTP data is made up of a header of image data (hereinafter, referred to as image header), and encoded data that is the main body of an image compressed on the basis of a line-based codec. The encoded data is image data encoded in coding units equivalent to N lines (N is not smaller than 1) in one field.

The image header can contain, for example, information related to image data, such as a picture number, a line block number (or a line number in the case when encoding is done in one-line units), and a subband number. It should be noted that the image header may be further separated into a picture header that is given for each picture, and a line block header that is given for each line block.

IP packets structured as described above are transmitted from the communication section 34 of the camera 21, and received by the communication section 41 of the camera controller 22. Then, the communication section 41 extracts an image header and encoded data included in each IP packet, and outputs the image header and the encoded data to the receive memory section 42.

In image data, a picture header is given for each picture. The communication section 34 of the camera 21 causes a picture header to be included in the image header of an IP packet including encoded data corresponding to the beginning of a picture, and transmits the IP packet. Hereinbelow, an IP packet with a picture header included in its image header will be referred to as picture header packet as appropriate.

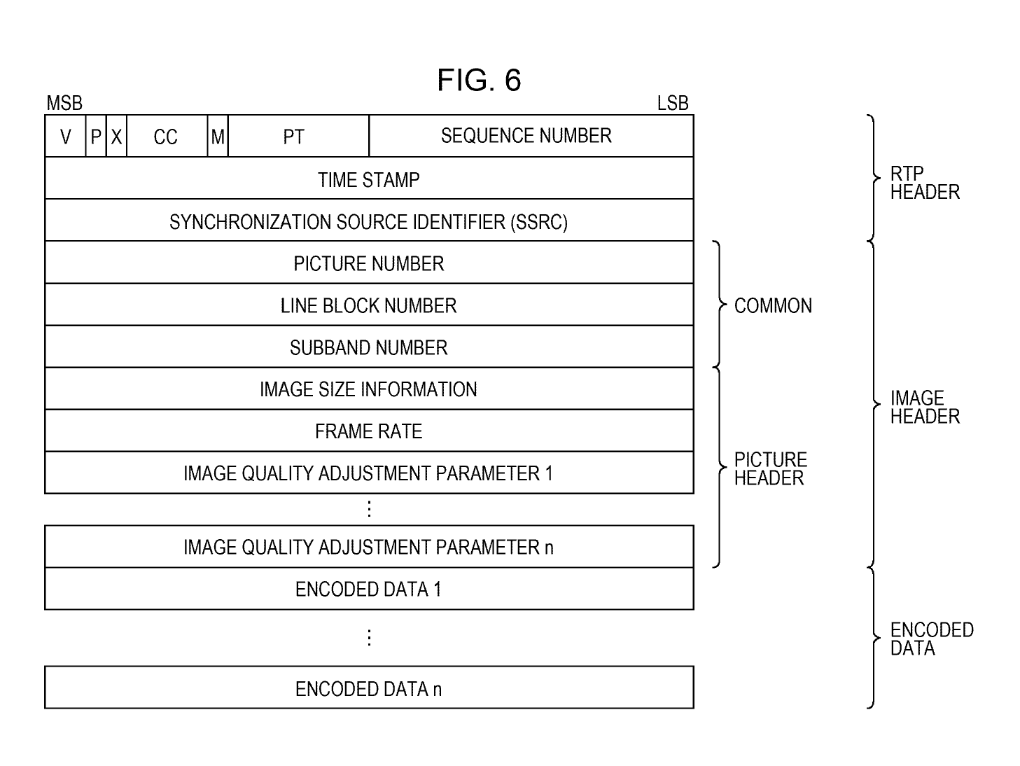

FIG. 6 shows a general data structure for a picture header packet. In a picture header packet, for example, an RTP header, an image header, and encoded data are placed.

The RTP header describes Version Bit (V), Padding Bit (P), Extension Bit (X), CSRC (Contributing Source) Count (CC), Marker Bit (M), Payload Type (PT), sequence number, time stamp, and Synchronization Source Identifier (SSRC).

The image header is made up of a common part that is common to all IP packets, and a picture header included in a picture header packet. As shown in FIG. 5, a picture number, a line block number, and a subband number are described in the common part.

The picture header describes image size information indicating an image size, a frame rate indicating the number of images updated per unit time, and n image quality adjusting parameters 1 to n that are variables for adjusting the quality of images. These pieces of information described in the picture header are referenced when the decoding section 43 of the camera controller 22 decodes encoded data.

Encoded data is stored in such a size that allows the encoded data to be stored in the payload of an IP packet. For example, in a picture header packet, a smaller size of encoded data than that in an IP packet that does not include a picture header is stored, in accordance with the size of data equivalent to the picture header included.

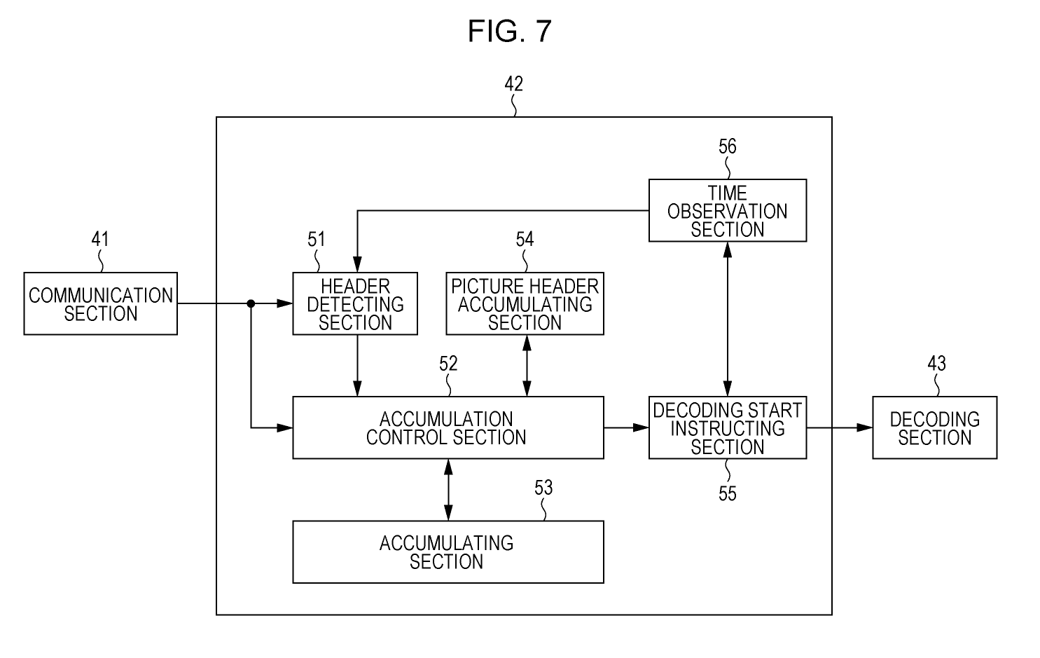

Next, FIG. 7 is a block diagram showing a detailed configuration of the receive memory section 42 shown in FIG. 4.

As shown in FIG. 7, the receive memory section 42 includes a header detecting section 51, an accumulation control section 52, an accumulating section 53, a picture header accumulating section 54, a decoding start instructing section 55, and a time observation section 56. When the communication section 41 receives a communication packet transmitted from the camera 21, the communication section 41 extracts an image header and encoded data included in the communication packet, and supplies the extracted image header and encoded data to each of the header detecting section 51 and the accumulation control section 52.

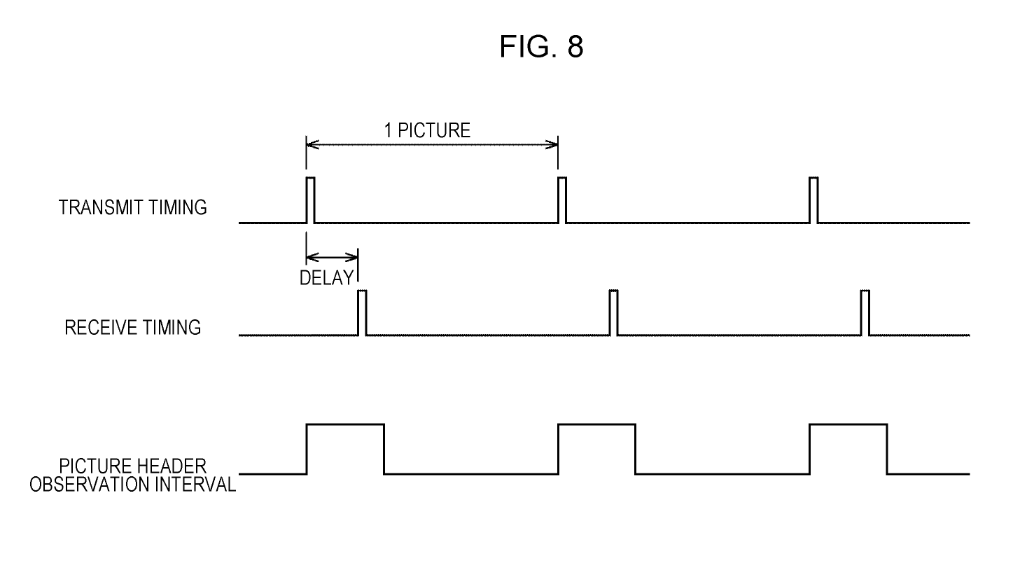

The header detecting section 51 detects the image header included in the data supplied from the communication section 41, and extracts a picture number, a line block number, and a subband number included in the image header. Also, if, within a predetermined picture header observation interval (see FIG. 8 described later), a picture header is included in the image header, the header detecting section 51 extracts the picture header.

For example, the header detecting section 51 recognizes the beginning position of a picture on the basis of the picture number extracted from the image header. Also, on the basis of the line block number extracted from the image header, the header detecting section 51 recognizes which line block in the picture the encoded data appended with the image header corresponds to. Also, on the basis of the picture header extracted from the image header, the header detecting section 51 recognizes that a picture header packet has been received.

Then, the header detecting section 51 outputs those pieces of recognized information to the accumulation control section 52 and the decoding start instructing section 55 as control information.

The accumulation control section 52 controls accumulation of the image header and encoded data supplied from the communication section 41 into the accumulating section 53, in accordance with the control information from the header detecting section 51. Also, in accordance with the control information from the header detecting section 51, if a picture header is included in the image header, the accumulation control section 52 accumulates the image header and encoded data also into the picture header accumulating section 54.

The accumulating section 53 temporarily accumulates the image header and the encoded data supplied from the accumulation control section 52. The picture header accumulating section 54 temporarily accumulates the image header including a picture header, and encoded data included in the same communication packet in which the image header is included.

Here, encoded data is image data encoded in coding units equivalent to N lines (N is not smaller than 1) in one field. In the accumulating section 53, a storage area for accumulating an image header and encoded data is allocated in accordance with the position of each encoded data on the image (that is, to which line (or line block) in the picture each encoded data corresponds to). Therefore, when accumulating an image header and encoded data into the accumulating section 53, the accumulating control section 52 accumulates the image header and the encoded data into a storage area allocated to the image header and the encoded data, in accordance with the position on the image as recognized by the header detecting section 51.

If, for example, a picture header packet transmitted by the communication section 34 of the camera 21 is lost in the transmission path, it follows that an image header including a picture header is not supplied from the communication section 41 to the header detecting section 51. In this case, the header detecting section 51 is unable to extract a picture header, and if the header detecting section 51 fails to extract a picture header even after a predetermined picture header observation interval (see FIG. 8 described later) has elapsed, the header detecting section 51 detects that a picture header packet has been lost. When the header detecting section 51 detects that a picture header packet has been lost, the accumulation control section 52 reads out the image header and the encoded data accumulated in the picture header accumulating section 54, causes the image header and the encoded data to be accumulated into the accumulating section 53, and inserts the image header and the encoded data in place of the lost data.

As described above, the accumulation control section 52 accumulates an image header including a picture header and encoded data also in the picture header accumulating section 54. Therefore, in the case when the camera controller 22 has already received a picture header packet, an image header including a picture header and encoded data are accumulated in the picture header accumulating section 54. Therefore, even if the picture header of a picture corresponding to the encoded data being accumulated in the accumulating section 53 is lost, the picture header of a picture preceding this picture is accumulated into the accumulating section 53 in place of the lost picture header.

It should be noted that, for example, as for the information to be held in the picture header accumulating section 54, other than constantly updating the information to the image header including the latest picture header and encoded data, for example, once an image header including a picture header and encoded data are held, those held information may be maintained. Moreover, since encoded data (image data) contained in a picture header packet generally has a large amount of information, the encoded data may be replaced by known data whose data size is smaller than the encoded data, and data (image header) other than the encoded data may be updated constantly.

The decoding start instructing section 55 determines a decoding start time instant set from the communication control section 46 shown in FIG. 4, as the decoding start time point for image data. Then, after the start of decoding, the decoding start instructing section 55 reads out encoded data encoded in coding units (that is, in units of lines or line blocks) from the accumulating section 53 and supplies the read encoded data to the decoding section 43, and also instructs the decoding section 43 to start decoding.

At this time, in this embodiment, the time point at which a preset fixed time has elapsed after the time point at which the beginning of a picture is recognized is set as the decoding start time point. For example, it is preferable to set the fixed time as the time that can absorb a delay such as a delay caused by fluctuations in data size in each coding unit or fluctuations in communication environment such as jitters of communication paths.

The time observation section 56 controls the time of the picture header observation interval under control from the decoding start instructing section 55. The time observation section 56 can be implemented as, for example, a timer. As for the picture header observation interval, since the timing of transmit/receive process between the camera 21 and the camera controller 22 is set by the camera controller 22, and a line-based codec is used, the observation interval can be set as the time that can absorb a delay such as a delay caused by fluctuations in data size in each coding unit or fluctuations in communication environment such as jitters of communication paths. Thus, it is possible to set the observation interval short.

Now, referring to FIG. 8, the observation interval will be described.

FIG. 8 shows a transmit timing indicating the timing when the camera 21 transmits a picture header packet, a receive timing when the camera controller 22 receives the picture header packet transmitted at the transmit timing, and a picture header observation interval set in the receive memory section 42.

As described above, the camera 21 transmits image data in accordance with a transmit start time instant specified by the transmit start instruction signal from the camera controller 22 and, for each one picture, transmits a picture header packet at the beginning of the corresponding picture. The picture header packet transmitted from the camera 21 is received by the camera controller 22 after being delayed in accordance with a delay time caused by fluctuations in data size in each coding unit or fluctuations in communication environment such as jitters of communication paths.

The picture header observation interval is a predetermined time including the time from the transmit start time instant to the time instant when the picture header packet is received, and is set to be less than the one-picture period (time necessary for transmitting one picture's worth of encoded data).

For example, in receivers according to the related art, when the picture header packet of the next picture is received after elapse of the one-picture period, it is detected that the picture header packet of the current picture has been lost. Accordingly, in this case, the decoding process is put on standby until the one-picture period elapses.

In contrast, in the camera controller 22, the picture header observation interval can be set shorter than the one-picture period, and if it is not possible to detect a picture header packet within the picture header observation interval, it is regarded that a picture header packet has been lost, and the decoding process can be started without waiting for the elapse of the one-picture period. Thus, images can be outputted with lower delay. At this time, the decoding process is performed using the picture header included in a picture header packet that has been already received. Thus, decoding can be performed with high image quality in comparison to the case where the decoding process is performed without using a picture header. That is, although image quality decreases in the case where the decoding process is performed without using a picture header, such a decrease in image quality can be avoided.

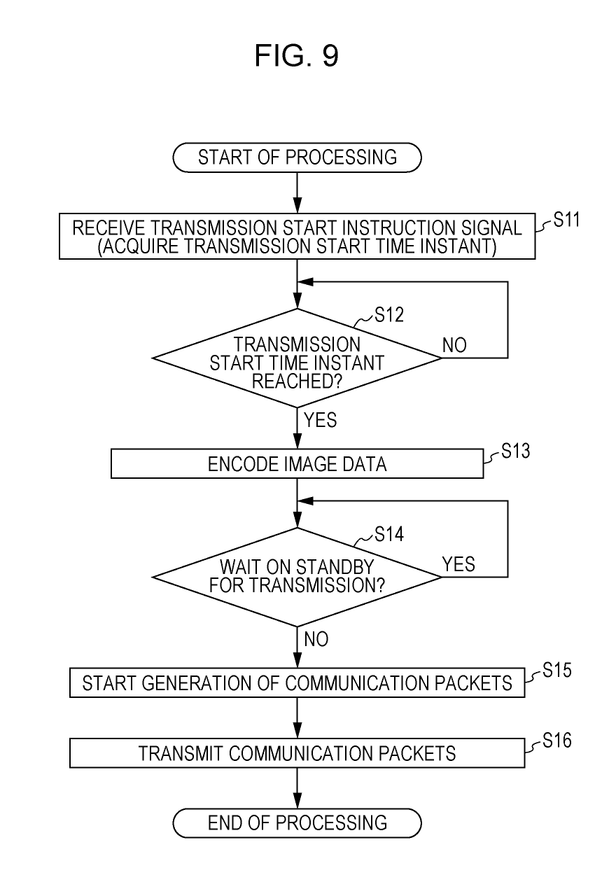

Next, referring to FIGS. 9 to 12, a description will be given of a transmit process in which the camera 21 transmits image data, and a receive process in which the camera controller 22 receives image data.

Next, FIG. 9 is a flowchart for explaining a transmit process in which the camera 21 transmits image data.

In step S11, the communication section 34 receives a transmission start instruction signal transmitted from the camera controller 22, and supplies the transmission start instruction signal to the communication control section 35. For example, when the camera 21 is activated and imaging by the imaging section 31 is started, the processing is started. The communication control section 35 puts processing on standby until the communication section 34 receives a transmission start instruction signal. Then, when the communication section 34 receives a transmission start instruction signal and supplies the transmission start instruction signal to the communication control section 35, the communication control section 35 acquires the transmission start time instant included in the transmission start instruction signal, and the processing proceeds to step S12.

In step S12, in accordance with the transmission start time instant acquired in step S11, the communication control section 35 determines whether or not the transmission start time instant has been reached. The communication control section 35 puts processing on standby until it is determined that the transmission start time instant has been reached. Thereafter, when it is determined that the transmission start time instant has been reached, the processing proceeds to step S13.

In step S13, the communication control section 35 controls the imaging section 31 so as to start output of image data to the encoding section 32, and the encoding section 32 starts encoding the image data outputted from the imaging section 31, in coding units of N lines (N is not smaller than 1) in one field. Then, the encoding section 32 outputs encoded data obtained by encoding the image data to the transmit memory section 33, and the encoded data is accumulated in the transmit memory section 33 depending on the communication path and the status of progress of the transmit process.

In step S14, the communication control section 35 determines whether or not to wait on standby for transmission of encoded data to the camera controller 22, and puts processing on standby until the timing at which to transmit encoded data is reached. Thereafter, when the timing at which to transmit encoded data is reached, the camera controller 22 controls the communication section 34 so as to generate communication packets to be transmitted to the camera controller 22. Thus, the communication section 34 reads out encoded data from the transmit memory section 33, and starts generation of communication packets including the encoded data.

At this time, when generating, for example, a communication packet including encoded data corresponding to the image at the beginning of a picture, the communication section 34 generates a communication packet including an image header including a picture header, and encoded data as described above.

After the process in step S15, the processing proceeds to step S16, and the communication section 34 transmits communication data to the camera controller 22, and the processing is ended.

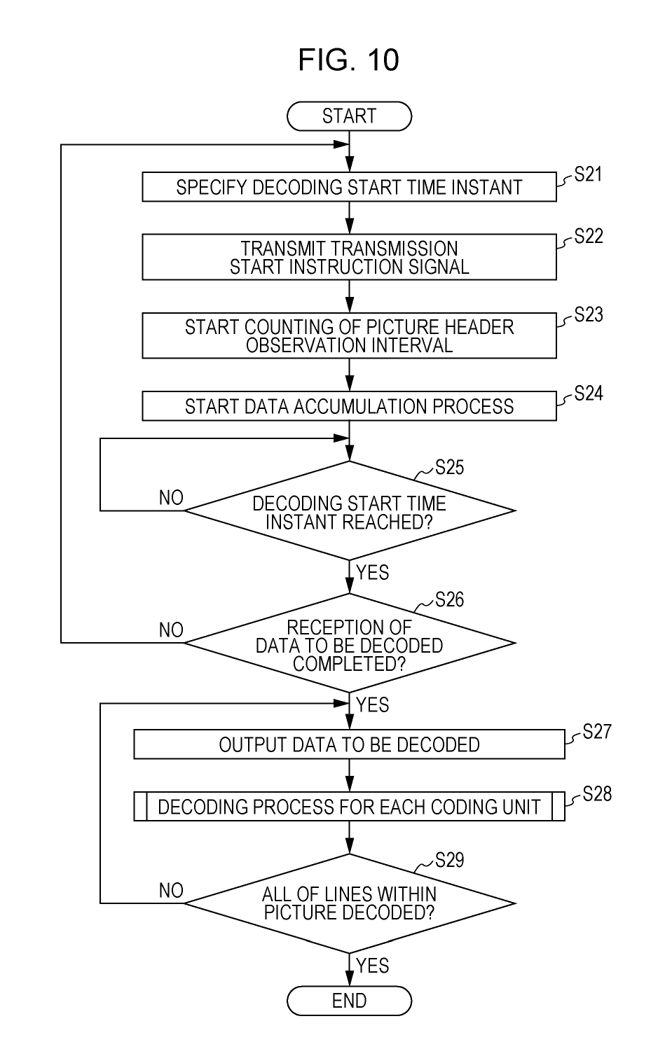

Next, FIG. 10 is a flowchart for explaining a receive process in which the camera controller 22 receives image data.

In step S21, the communication control section 46 specifies a decoding start time instant with respect to the decoding start instructing section 55 of the receive memory section 42. The decoding start time instant is a time instant based on a synchronizing signal from the synchronization control section 45, and indicates the time instant when the decoding section 43 is to start the decoding process. The processing then proceeds to step S22.

In step S22, the communication control section 46 transmits a transmission start instruction signal including a transmission start time instant to the camera 21 via the communication section 41. The transmission start time instant is a time instant based on a synchronizing signal from the synchronization control section 45, and indicates the time instant when the camera 21 is to start transmission of image data. The transmit start instruction signal transmitted in step S21 is received in step S11 shown in FIG. 9.

After the process in step S22, the processing proceeds to step S23, and in the receive memory section 42, the decoding start instructing section 55 sets a picture header observation interval with respect to the time observation section 56, in accordance with the decoding start time instant specified by the communication control section 46. Thus, the time observation section 56 starts counting of the picture header observation interval, and the processing proceeds to step S24.

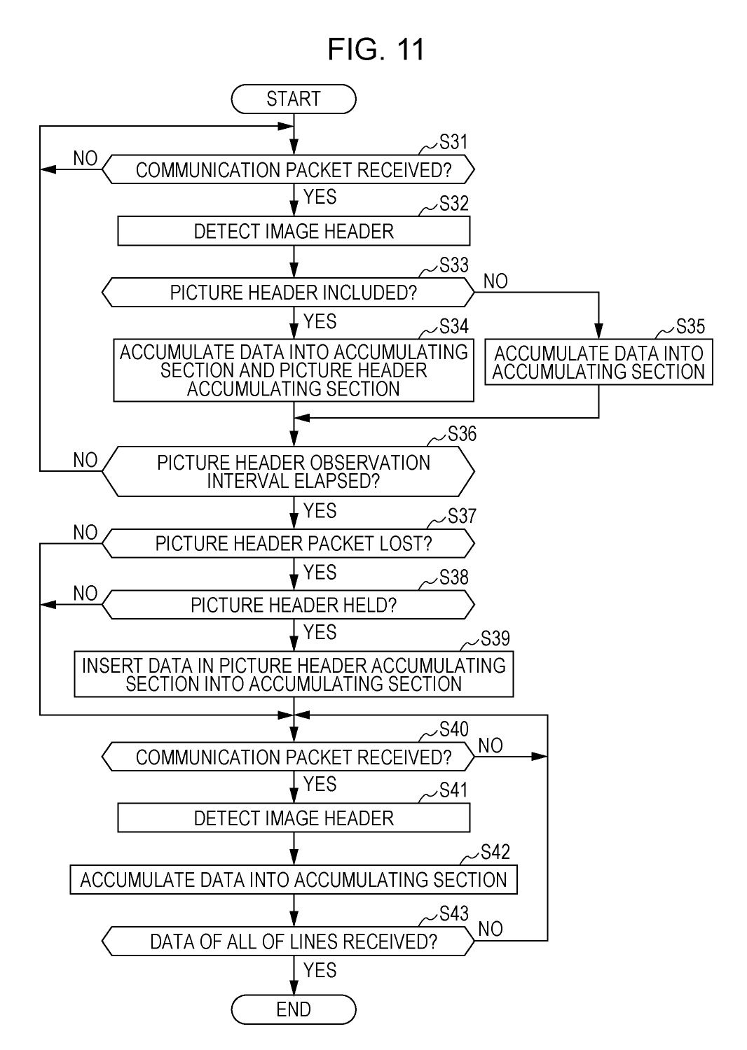

In step S24, in the camera controller 22, communication packets transmitted from the camera 21 are received by the communication section 41, and a data accumulation process is started. In the data accumulation process, the receive memory section 42 accumulates an image header and encoded data. The data accumulation process will be described later with reference to FIG. 11.

In step S25, the decoding start instructing section 55 determines whether or not the decoding start time instant specified in step S21 has been reached, and puts processing on standby until it is determined that the decoding start time instant has been reached. Then, if it is determined in step S25 by the decoding start instructing section 55 that the decoding start time instant has been reached, the processing proceeds to step S26, and the decoding start instructing section 55 determines whether or not reception of the data to be decoded is completed at this point in time.

As described above, in this embodiment, a line-based codec is adopted and, for example, the decoding start instructing section 55 detects whether or not encoded data corresponding to the image of the line block at the beginning of a picture is accumulated in the accumulating section 53. Then, if the encoded data is accumulated in the accumulating section 53, the decoding start instructing section 55 determines whether or not reception of the data to be decoded is completed.

If it is determined in step S26 by the decoding start instructing section 55 that reception of the data to be decoded is not completed, the processing returns to step S21, and the transmit/receive timing is readjusted with respect to the image data to be transmitted/received. Thereafter, the same processing is repeated.

On the other hand, if it is determined in step S26 by the decoding start instructing section 55 that reception of the data to be decoded is completed, the processing proceeds to step S27.

In step S27, the decoding start instructing section 55 reads out encoded data to be decoded and an image header that are accumulated in the accumulating section 53 via the accumulation control section 52, and supplies the encoded data to be decoded and the image header to the decoding section 43.

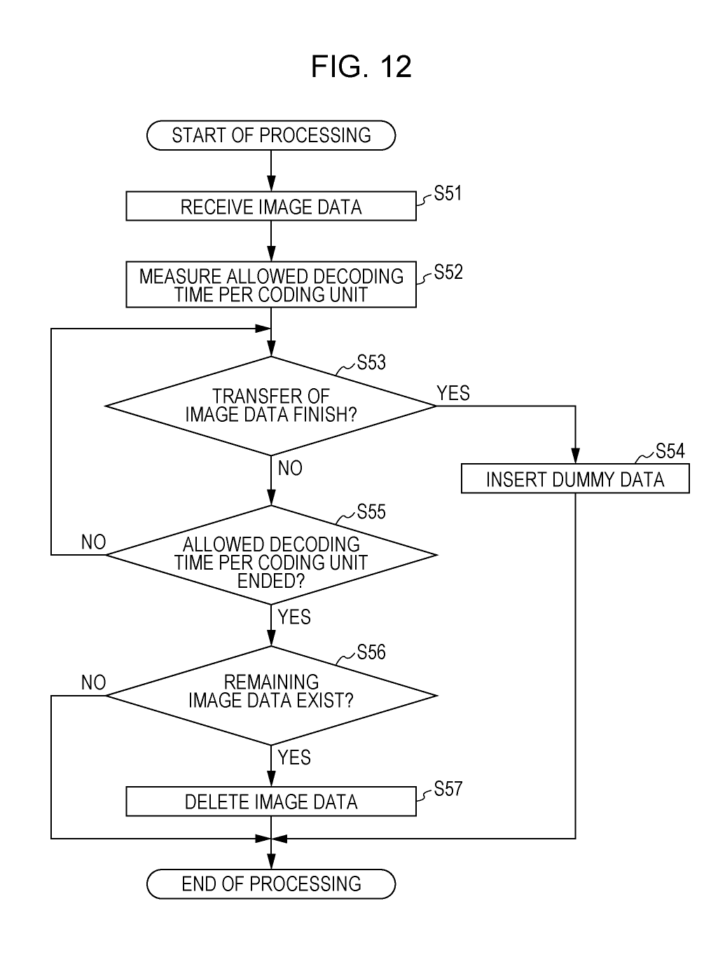

After the process in step S27, the processing proceeds to step S28, and a decoding process for each coding unit is performed. The decoding process for each coding unit will be described later with reference to FIG. 12.

After the process in step S28, the processing proceeds to step S29, and the decoding start instructing section 55 determines whether or not all of lines within the picture have been decoded.

If it is determined in step S29 by the decoding start instructing section 55 that not all of lines within the picture have been decoded, the processing returns to step S27, and thereafter, the same processing is repeated. That is, in this case, in step S27, the coding unit following the immediately preceding coding unit decoded in step S28 is set as the decoding target, and data of the coding unit is read out from the accumulating section 53 and supplied to the decoding section 43, and the decoding process for the coding unit is performed.

On the other hand, if it is determined in step S29 by the decoding start instructing section 55 that all of lines within the picture have been decoded, the processing is ended.

Next, FIG. 11 is a flowchart for explaining the data accumulation process which is started in step S24 shown in FIG. 10.

In step S31, the header detecting section 51 determines whether or not the communication section 41 has received a communication packet. The header detecting section 51 puts processing on standby, until the communication section 41 receives a communication packet and supplies data extracted from the communication packet.

When data is supplied from the communication section 41, in step S31, the header detecting section 51 determines that the communication section 41 has received a communication packet. Then, the processing proceeds to step S32, and the header detecting section 51 detects an image header from the data supplied from the communication section 41. Then, the header detecting section 51 acquires various kinds of information contained in the image header.

After the process in step S32, the processing proceeds to step S33, and the header detecting section 51 determines whether or not a picture header is included in the image header detected in step S32.

If it is determined in step S33 by the header detecting section 51 that a picture header is included in the image header, the processing proceeds to step S34. In step S34, the header detecting section 51 supplies control information indicating that an image header including a picture header has been detected, to the accumulation control section 52. Thus, the accumulation control section 52 controls each of the accumulating section 53 and the picture header accumulating section 54 so as to accumulate the image header and encoded data.

On the other hand, if it is determined in step S33 by the header detecting section 51 that a picture header is not included in the image header, the processing proceeds to step S35. In step S35, the header detecting section 51 supplies control information indicating that an image header including a picture header has not been detected, to the accumulation control section 52. Thus, the accumulation control section 52 controls the accumulating section 53 to accumulate the image header and encoded data.

After the process in step S34 or S35, the processing proceeds to step S36, and the time observation section 56 determines whether or not the picture header observation interval of which counting has been started in step S23 shown in FIG. 10 has elapsed. If it is determined in step S36 by the time observation section 56 that the picture header observation interval has not elapsed, the processing returns to step S31, and thereafter, the same processing is repeated.

On the other hand, if it is determined in step S36 by the time observation section 56 that the picture header observation interval has elapsed, the time observation section 56 notifies the header detecting section 51 of the elapse of the picture header observation interval, and the processing proceeds to step S37.

In step S37, the header detecting section 51 determines whether or not a picture header packet has been lost. For example, if the header detecting section 51 has previously determined in step S33 that a picture header is included the image header by the time when the process in step S37 is performed, the header detecting section 51 determines that a picture header packet has not been lost.

If it is determined in step S37 by the header detecting section 51 that a picture header packet has been lost, the processing proceeds to step S38, and the accumulation control section 52 determines whether or not a picture header is held in the picture header accumulating section 54. For example, if a picture header has been previously received during a process of receiving a picture preceding the current picture, it follows that a picture header is held in the picture header accumulating section 54.

If it is determined in step S38 by the accumulation control section 52 that a picture header is held in the picture header accumulating section 54, the processing proceeds to step S39. In step S39, the accumulation control section 52 reads out the image header and the encoded data accumulated in the picture header accumulating section 54, and inserts the image header and the encoded data into the accumulating section 53.

On the other hand, in the case where it is determined in step S37 that a picture header packet has not been lost, in the case where it is determined in step S38 that a picture header is not held in the picture header accumulating section 54, or after the process in step S39, the processing proceeds to step S40.

From step S40 onwards, until data of all of the remaining lines is received, the process of accumulating an image header and encoded data into the accumulating section 53 is repeated. That is, in step S40, as in the process in step S31, processing is put on standby until it is determined that the communication section 41 has received a communication packet. In step S42, as in the process in step S32, an image header is detected. Then, in step S42, as in the process in step S35, the image header and encoded data are accumulated into the accumulating section 53.

Thereafter, in step S43, the header detecting section 51 determines whether or not data of all of lines has been received. If it is determined that data of all of lines has not been received, the processing returns to step S40, and thereafter, the same processing is repeated. On the other hand, if it is determined in step S43 that data of all of lines has been received, the processing is ended.

Next, FIG. 12 is a flowchart for explaining the decoding process for each coding unit in step S28 shown in FIG. 10.

In step S51, the decoding section 43 receives the image data (the encoded data and the image header) that has been read out from the accumulating section 53 and outputted by the decoding start instructing section 55 in step S27 shown in FIG. 10, and the processing proceeds to step S52.

In step S52, the decoding start instructing section 55 measures the allowed decoding time per coding unit. Here, the allowed decoding time per coding unit means the time that can be spent for displaying image data of a single coding unit. For example, when decoding a video of 1080/60p (the progressive scheme of 60 fps with the screen size of 2200×1125), the time that can be spent for display of one line is approximately 14.8 [μs] if the blank time is taken into account, and is approximately 15.4 [μs] if the blank time is not taken into account. If the coding unit is a line block of N lines, the allowed decoding time per coding unit is N times the above-mentioned time that can be spent for display of one line.

After the process in step S52, the processing proceeds to step S53, and the decoding start instructing section 55 determines whether or not transfer of image data from the accumulating section 53 to the decoding section 43 finishes by the time the processing time per coding unit ends.

If it is determined in step S53 by the decoding start instructing section 55 that transfer of image data finishes earlier than the end of the processing time per coding unit, that is, only a smaller size of image data than expected has been received, the processing proceeds to step S54.

In step S54, the decoding start instructing section 55 inserts dummy data to the corresponding line (or line block), without waiting for the completion of reception of the above-mentioned image data. That is, in this case, it is supposed that reception of the image data to be decoded is not completed for reasons such as communication delay. If the completion of reception of the image data to be decoded is waited for at this time, the synchronization timing shifts and image display is delayed. Thus, dummy data is inserted. As the dummy data inserted at this time, for example, image data of the same line (or line block) in the immediately preceding picture (or picture preceding the immediately preceding picture) can be used. It should be noted that the dummy data used is not limited to this example, but arbitrary data can be used, such as fixed image data, or data predicted by motion compensation or the like.

On the other hand, if it is determined in step S53 by the decoding start instructing section 55 that transfer of image data does not finish earlier than the end of the processing time per coding unit, the processing proceeds to step S55.

In step S55, the decoding start instructing section 55 determines whether or not the allowed decoding time per coding unit ends before transfer of image data finishes. If it is determined in step S55 by the decoding start instructing section 55 that the allowed decoding time per coding unit does not end before transfer of image data finishes, the processing returns to step S53, and thereafter, the same processing is repeated.

On the other hand, if it is determined in step S55 by the decoding start instructing section 55 that the allowed decoding time per coding unit has ended before transfer of image data finishes, the processing returns to step S56.

In step S56, the decoding start instructing section 55 determines whether or not image data to be decoded remains in the accumulating section 53. If it is determined in step S56 by the decoding start instructing section 55 that image data to be decoded remains in the accumulating section 53, the processing proceeds to step S57, and the decoding start instructing section 55 deletes the image data remaining in the accumulating section 53.

On the other hand, in the case where it is determined in step S56 that image data to be decoded does not remain in the accumulating section 53, after the process in step S57, or after the process on step S54, the processing is ended.

It should be noted that in step S55, when the processing time for one coding unit ends, it is preferable to instruct decoding for the next coding unit while continuously operating the counter used for time measurement, without suspending or resetting the counter. This allows the decoding process to be performed without causing variations in decoding timing for the coding unit of every line block, for example.

Alternatively, a time control section (not shown) may be provided inside the camera controller 22 separately from the counter used for time measurement and, for example, in step S54, the receive memory section 42 or the decoding section 43 may be notified of the start/end timing of processing for each coding unit from this time control section.

Then, the decoding process for each coding unit is repeated until processing of all of lines within the picture finishes, and the receive process ends at the time when the processing of all of the lines finishes.

As described above, in the camera controller 22, when a picture header packet including decode information of a picture is lost, the image header and the encoded data held in the picture header accumulating section 54 can be inserted into the accumulating section 53 to complement the lost image header and encoded data. Thus, in the decoding section 43, the decoding process can be performed by using the complemented image header and encoded data, thereby avoiding a decrease in image quality due to loss of the picture header packet.

Also, the camera controller 22 can set the timing of transmit/receive process between the camera 21 and the camera controller 22 so that the picture header observation interval can be set short. Thus, the standby time in the case when a picture header packet is lost can be made short, thereby making it possible to output images with low delay.

In particular, in the communication system 20, it is possible to take advantage of the low delay characteristic of a line-based codec, thereby enabling image transmission with low delay and high image quality even in such network environments where errors occur.

In the case where, for example, the communication system 20 includes a plurality of cameras 21, when managing or combining a plurality of pieces of image data on the camera controller 22 side, the camera controller 22 can act as a timing controller to achieve synchronization between the pieces of image data.

Also, the synchronization control section 45 specifies, with respect to the decoding start instructing section 55 within the receive memory section 42, a decoding start time instant that is separated from the above-described transmission start time instant by a time interval necessary for absorbing fluctuations in communication environment. Then, the decoding start instructing section 55 in the receive memory section 42 determines a decoding start time point on the basis of the specified decoding start time instant, and instructs starting of decoding of image data in coding units. Also, when a picture header is lost, the lost picture header is complemented by a picture header held in the picture header accumulating section 54, thereby allowing image data transmitted in a synchronized fashion to be decoded in a stable, synchronized state while absorbing fluctuations in communication environment, and the influence of loss or the like.

It should be noted that in the communication system 20, the communication sections 34 and 41 perform control at the Media Access Control (MAC) layer in the Time Division Multiple Access (TDMA) scheme or Carrier Sense Multiple Access (CSMA) scheme. Also, the communication control sections 35 and 46 performs control at the MAC layer based on Preamble Sense Multiple Access (PSMA) that identifies a packet from correlation of the preamble rather than the carrier.

Further, in the communication system 20, other than specifying a transmission start time instant by transmitting and receiving a transmission start signal (control data) by using a communication packet, the transmission start time instant may be specified by using a timing signal communicated on a separate line.

Also, other than detecting loss of a picture header packet at the timing when the picture header observation interval has elapsed, even within the picture header observation interval, loss of a picture header packet can be detected by monitoring packet numbers. For example, suppose that during operation with the picture numbers being 0 to 10 (the packet with the picture number 0 being the picture header packet), packets are received in the order of packet numbers 8, 9, 10, and 1 within the picture header observation interval. At this time, upon receiving the packet with the packet number 1, it is detected that a picture header packet has been lost, and an operation can be performed so as to complement the picture header packet. Thus, the loss of the picture header packet can be detected at earlier timing, thereby enabling the decoding process to be started with lower delay.

It should be noted that the series of processes described above can be either executed by hardware or executed by software. If the series of processes is to be executed by software, a program constituting the software is installed into a computer embedded in dedicated hardware, or into, for example, a general-purpose personal computer that can execute various kinds of functions when installed with various kinds of programs, from a program-recording medium.

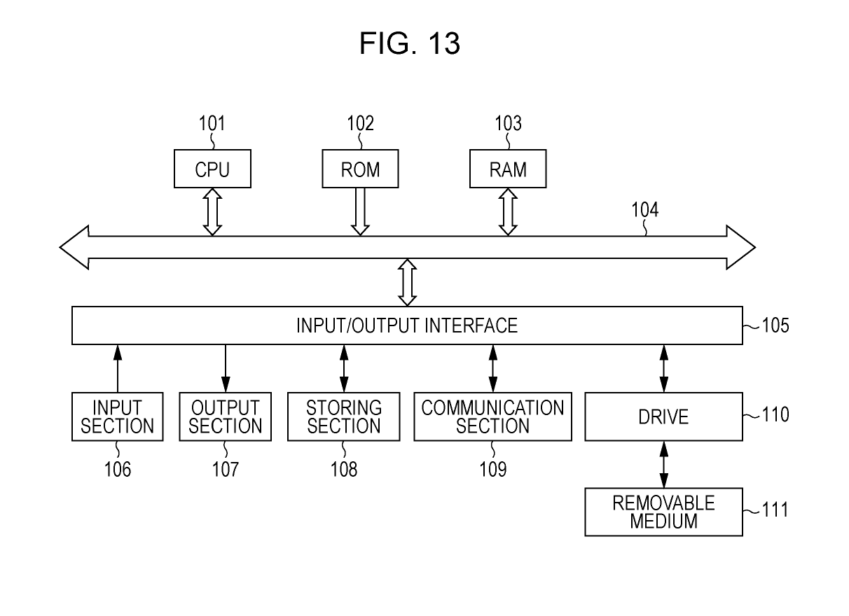

FIG. 13 is a block diagram showing an example of the hardware configuration of a computer that executes the above-mentioned series of processes by a program.

In the computer, a Central Processing Unit (CPU) 101, a Read Only Memory (ROM) 102, and a Random Access Memory (RAM) 103 are connected to each other via a bus 104.

The bus 104 is further connected with an input/output interface 105. The input/output interface 105 is connected with an input section 106 formed by a keyboard, a mouse, a microphone, or the like, an output section 107 formed by a display, a speaker, or the like, a storing section 108 formed by a hard disk, a non-volatile memory, or the like, a communication section 109 formed by a network interface or the like, and a drive 110 for driving a removable medium 111 such as a magnetic disc, an optical disc, a magneto-optical disc, or a semiconductor memory.

In the computer configured as described above, the above-mentioned series of processes is performed when the CPU 101 loads a program stored in the storing section 108 into the RAM 103 via the input/output interface 105 and the bus 104, and executes the program, for example.

The program executed by the computer (CPU 101) is provided by being recorded on the removable medium 111 that is a packaged medium formed by, for example, a magnetic disc (including a flexible disc), an optical disc (such as a Compact Disc-Read Only Memory (CD-ROM) or a Digital Versatile Disc (DVD)), a magneto-optical disc, a semiconductor memory, or the like, or via a wired or wireless transmission medium such as a local area network, the Internet, or digital satellite broadcast.

Then, the program can be installed into the storing section 108 via the input/output interface 105, by inserting the removable medium 111 in the drive 110. Also, the program can be received by the communication section 109 via a wired or wireless transmission medium, and installed into the storing section 108. Alternatively, the program can be pre-installed into the ROM 102 or the storing section 108.

The various processes described with reference to the flowcharts mentioned above may not necessary be executed on time series in the order as described in the flowcharts, but may also include processes that are executed in parallel or independently (for example, parallel processes or object-based processes). Also, the program may be a program that is processed by a single CPU or processed in a distributed fashion among a plurality of CPUs.

The term system as used in this specification refers to the entirety of an apparatus made up of a plurality of devices.

The present disclosure contains subject matter related to that disclosed in Japanese Priority Patent Application JP 2010-132459 filed in the Japan Patent Office on Jun. 9, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A receiver comprising:
a receiving section that receives communication packets transmitted from a transmitter, the transmitter transmitting the communication packets each including encoded data obtained by encoding image data, and an image header containing information related to the image data, sequentially from the encoded data corresponding to the beginning of an image;
a first accumulating section that accumulates the encoded data and the image header included in each of the communication packets received by the receiving section;
a detecting section that detects a picture header from the image header of each of the communication packets received by the receiving section, in a predetermined observation interval, the picture header being transmitted together with the encoded data corresponding to the beginning of the image;
a second accumulating section that accumulates the picture header detected by the detecting section; and
a control section that reads out the picture header accumulated in the second accumulating section, and causes the picture header to be accumulated into the first accumulating section, if the picture header is not detected by the detecting section within the observation interval.

2. The receiver according to claim 1, further comprising:
a transmission start instructing section that instructs a time instant at which to start transmission of the communication packets, with respect to the transmitter,
wherein the observation interval is a predetermined time from the time instant instructed by the transmission start instructing section, and is set to be less than a time necessary for transmitting one image's worth of the encoded data.

3. The receiver according to claim 1, wherein the encoded data is encoded by a line-based codec.

4. The receiver according to claim 1, further comprising:
a determining section that determines whether or not the picture header is accumulated in the second accumulating section,
wherein if it is determined by the determining section that the picture header is accumulated in the second accumulating section, the control section causes the picture header accumulated in the second accumulating section to be accumulated into the first accumulating section.

5. The receiver according to claim 1, wherein the second accumulating section updates accumulated information every time the picture header is detected by the detecting section.

6. The receiver according to claim 1, wherein the second accumulating section accumulates the image header including the picture header, and accumulates the encoded data included in the same communication packet as the picture header, or known data whose data size is smaller than the encoded data.

7. A receiving method comprising:
receiving communication packets transmitted from a transmitter, the transmitter transmitting the communication packets each including encoded data obtained by encoding image data, and an image header containing information related to the image data, sequentially from the encoded data corresponding to the beginning of an image;
accumulating the encoded data and the image header included in each of the received communication packets into a first accumulating section;
detecting a picture header from the image header of each of the communication packets, in a predetermined observation interval, the picture header being transmitted together with the encoded data corresponding to the beginning of the image;
accumulating the detected picture header into a second accumulating section; and
reading out the picture header accumulated in the second accumulating section, and causing the picture header to be accumulated into the first accumulating section, if the picture header is not detected within the observation interval.

8. A communication system comprising:
a transmitter that transmits communication packets each including encoded data obtained by encoding image data, and an image header containing information related to the image data, sequentially from the encoded data corresponding to the beginning of an image; and
a receiver having
a receiving section that receives the communication packets transmitted from the transmitter,
a first accumulating section that accumulates the encoded data and the image header included in each of the communication packets received by the receiving section,
a detecting section that detects a picture header from the image header of each of the communication packets received by the receiving section, in a predetermined observation interval, the picture header being transmitted together with the encoded data corresponding to the beginning of the image,
a second accumulating section that accumulates the picture header detected by the detecting section, and
a control section that reads out the picture header accumulated in the second accumulating section, and causes the picture header to be accumulated into the first accumulating section, if the picture header is not detected by the detecting section within the observation interval.
